(19) United States
(12) Patent Application Publication
(10) Pub. No.: US 2024/0375123 A1
(43) Pub. Date: Nov. 14, 2024

(54) MEMBRANE SPARGERS FOR GRAVITY SEPARATORS AND FLOTATION MACHINES

(71) Applicant: FLSmidth A/S, Valby (DK)

(72) Inventors: Jacob Parrott, Midvale, UT (US); Thien Sok, Sandy, UT (US); Lance Christodoulou, South Jordan, UT (US); Joon Won Lee, Salt Lake City, UT (US)

(21) Appl. No.: 18/564,597

(22) PCT Filed: May 27, 2022
(86) PCT No.: PCT/IB2022/055014

§ 371 Date: Nov. 27, 2023

Related U.S. Application Data
(60) Provisional application No. 63/194,161, filed on May 27, 2021.

(51) Int. Cl. B03D 1/24; B03D 1/14

(52) U.S. Cl. CPC B03D 1/247; B03D 1/1456; B03D 1/245

(57) ABSTRACT

A separator device (100) includes a separation chamber (107) defined at its lower end by a fluidization fluid panel (111). The separation chamber (107) receives incoming slurry (113) via a slurry inlet (102). The separator device may be characterized in that means (122) for supplying pre-sheared aerated fluidization fluid is provided above the fluidization fluid panel (111). The means (122) for supplying pre-sheared aerated fluidization fluid includes a novel sparger (119) comprising a flexible perforated membrane which is configured to supplementally shear the pre-sheared aerated fluidization fluid and uniformly distribute microbubbles (129) throughout the separation chamber (107).

### FIELD OF THE INVENTION

Embodiments of the present invention pertain to improvements to gravity separation and flotation machines, in particular, “rotorless” gravity- and fluidized bed-assisted flotation apparatus. In particular, embodiments of the present invention relate to a unique flexible perforated membrane sparger for optimizing bubble size distributions within a fluidized bed and/or facilitating periodic sparger purging. Embodiments may further include a method involving the dual-shearing of aerated fluidization fluids.

### BACKGROUND OF THE INVENTION

Reference to background art herein is not to be construed as an admission that such art constitutes common general knowledge in the arts.

In many industrial processes, fluidized beds are used to suspend solids and perform various separations within equipment. An example of such device can be found in U.S. Pat. No. 6,814,241 B1. Another example can be found in the FLSmidth® REFLUX® classifier, a specialized gravity-assisted separation device.

Turning now to FIGS. 1-3, such conventional separator devices 1 may incorporate a vertically-oriented separation chamber 7 defined by a tank wall 3. The separation chamber 7 may be fed with incoming slurry 13 at its upper region via a slurry inlet 2. The separation chamber 7 may be defined at its lower end by a fluidization fluid panel 11 which may be provided with openings 10 (e.g., perforations, slots, orifices, or nozzles). Incoming fluidization fluid 12 may be received by a fluidization fluid inlet 4 and subsequently delivered to a lower fluidization fluid distribution chamber 8 defined at its upper end, by the fluidization fluid panel 11. The fluidization fluid panel 11 separates the fluidization fluid distribution chamber 8 from the separation chamber such that the openings 10 therein allow fluidization fluid to pass from the fluidization fluid distribution chamber 8 upwardly through the panel 11 and into the separation chamber 7. Thus, the two chambers 7, 8 fluidly communicate with one another, wherein contents within the separation chamber 7 are prevented or discouraged from backflowing into the lower fluidization fluid distribution chamber 8.

Solids within the incoming slurry 13 are separated by gravity, wherein finer or less-dense particles are discharged at an upper portion of the device 1 by passing over a weir 16 (as overflow 15), and entering into a collection launder 17. Coarser or denser particles fail to move upward within the separation chamber 7 and end up being discharged through a lower outlet 9 passing through a central opening in the fluidization fluid panel 11. The coarser or denser particles pass through/by the fluidization fluid distribution chamber 8 and exit the bottom of the device 1 (as underflow 14).

An upper separation chamber 6 may be provided between the weir 16 and the separation chamber 7, and this upper separation chamber 6 may comprise a number of lamellae or spaced (e.g., parallel) inclined plates 5 to improve separations. By adjusting flows of incoming slurry 13 and fluidization fluid 12, separations can be optimized for a particular process.

Similar units may be designed for use for flotation, in addition to, or in lieu of classification. An example can be seen in WO 2020152651 A1, where the incoming fluidization fluid 12 is aerated within the fluidization fluid distribution chamber 8 prior to passing through the fluidization fluid panel 11 and into the separation chamber 7. Bubbles within the separation chamber 7 combine with hydrophobic particles and move upwardly where they eventually make their way to the collection launder 17 as froth overflow 15. Hydrophilic particles fail to bind with the bubbles within the separation chamber 7 and eventually make their way to the lower outlet 9 as underflow 14.

A problem with such devices, is that the openings 10 in the fluidization fluid panel 11 (e.g., orifices extending through panel 11), can clog and/or may not adequately provide controlled bubble size distributions, uniform bubbly zones, or fine bubble size adjustments within the separation chamber 7. Openings 10 comprising a large number of nozzles or spargers provided to the fluidization fluid panel 11 can significantly increase manufacturing costs and total time to fabricate and service. Nozzles and spargers provided to fluidization fluid panel 11 can also clog over time and may be difficult to purge without removal.

Embodiments of the present invention aim to improve upon existing gravity separation apparatus and fluidized bed-assisted (i.e., “rotorless”) flotation machines by incorporating low-cost flexible perforated membrane structures which synergistically work together to provide a more homogeneous bubble size distribution, more uniform introductions of aerated fluidization fluid, and improved recoveries. By virtue of their ability to flex, openings may be configured to temporarily elastically expand, thus, facilitating the removal of particle occlusions.

### OBJECTS OF THE INVENTION

It is an aim that embodiments of the invention provide an improved gravity separation, gravity-assisted classification, or gravity-assisted flotation apparatus which overcomes or ameliorates one or more of the disadvantages or problems described above, or, which at least provides a useful alternative to related conventional apparatus.

An aim of some embodiments of the invention may include providing an improved separator device 100 which exhibits much finer bubble sizes within its separation chamber 107 to improve efficiency, recovery, and/or operational performance of the separator device 100, without limitation.

Another aim of some embodiments of the invention may include providing an improved separator device 100 which is less prone to plugging of openings 11 used to distribute aerated fluidization fluid to a separation chamber 107, without limitation.

Another aim of some embodiments of the invention may include providing an improved separator device 100 having aerated fluidization fluid distribution means for providing aerated fluidization fluid to its separation chamber 107 which comprises a flexible perforated membrane element configured to expand to clear obstructions of openings or perforations therein, without limitation.

Another aim of some embodiments of the invention may include providing an improved separator device 100 which is capable of double-shearing an aerated fluidization fluid prior to its introduction into its separation chamber 107, in order to provide controlled smaller bubble sizes and tighter bubble size distributions without limitation.

A further aim of some embodiments of the invention may include providing an improved separator device 100 which provides a more even distribution of gas/liquid mixtures proximate a lower and/or central region of its separation chamber 107, without limitation.

Yet another aim of some embodiments of the invention may include providing an improved separator device 100 which allows periodic purging and/or cleaning of clogged pores by virtue of the provision of a flexible perforated membrane sparger; wherein periodically, the pressure of aerated fluidization fluid behind the flexible perforated membrane can be temporarily increased to cause temporary elastic deformation, flexing, and/or expansion of a surface area of the flexible membrane, thereby temporarily increasing a size or minimum width of perforations or openings extending through the flexible membrane. As such, aerated fluidization fluid under increased pressure can pass through the temporarily-increased sized perforations or openings to help dislodge particles from incoming slurry 13 which may have occluded the perforations or openings during operation of the separator device 100.

A further aim of some embodiments of the invention may include providing an improved separator device 100 that provides aerated fluidization fluid to its separation chamber 7, which is easier and cheaper to manufacture and service, without limitation.

It should be understood that not every embodiment may be configured to obtain each and every one of the abovementioned objects. However, specific embodiments may demonstrate the ability to achieve or satisfy at least one or more of the abovementioned goals.

Other preferred objects of the present invention will become apparent from the following description.

### SUMMARY OF INVENTION

According to embodiments of the invention, a separator device 100 is disclosed. The separator device 100 may be utilized for gravity separation, classification of particles by size and/or density, and/or segregation of particles by hydrophobicity (e.g., flotation separation or coarse particle flotation). The separator device 100 may be fed with an incoming slurry 13 containing the particles to be separated (e.g., by virtue of gravity-assisted classification or flotation by minerology).

A separator device (100) according to embodiments may comprise a separation chamber (107). The separation chamber (107) may be defined at its lower end by a fluidization fluid panel (111). The separation chamber (107) may be further defined (i.e., bounded) on its sides by a tank wall (103).

A lower outlet (109) may be provided at a lower end of the separator device (100). The lower outlet (109) may extend downwardly through a central region of the lower fluidization fluid panel (111).

A launder (117) may be provided at an upper end of the separator device (100). The separator device (100) may further comprise a slurry inlet (102) for receiving incoming slurry (113) into the separation chamber (107).

The separator device (100) may be characterized in that means (122) for supplying pre-sheared aerated fluidization fluid may be provided above the fluidization fluid panel (111). The means (122) for supplying pre-sheared aerated fluidization fluid may include a sparger (119), in particular, a sparger comprising a flexible perforated membrane structure.

In some embodiments, the sparger (119) may be configured as one of the group consisting of: a straight tube, a curved tube, a coil, a disc, a puck, a panel, and a plate, without limitation.

In some embodiments, the sparger (119) may comprise two ends. In some embodiments, the sparger (119) may be fed at one of its ends (e.g., a first proximal end) with the pre-sheared aerated fluidization fluid, without limitation. In some embodiments, the sparger (119) may be fed at both of its ends (e.g., a first proximal end and a second distal end) with the pre-sheared aerated fluidization fluid, without limitation.

In some embodiments, the separator device (100) may comprise a plurality of the aforementioned sparger (119), without limitation. In some embodiments, each of the plurality of sparger (119) may be nested and/or packed together, without limitation.

In some embodiments, each of the plurality of sparger (119) may be of different sizes or shapes, without limitation. In some embodiments, each of the plurality of sparger (119) may be oriented differently in space with respect to one or more components of the separator (100) device, without limitation.

In some embodiments, the sparger (119) (or plurality thereof) may be horizontally-arranged, without limitation. In some embodiments, the sparger (119) (or plurality thereof) may be inclined so as to follow an angle of the fluidization fluid panel (111), without limitation.

In some embodiments, the pre-sheared aerated fluidization fluid may be produced by combining fluidization fluid (112) with a gas (118) and then subsequently passing the mixture thereof through a shearing device (126) downstream of where the fluidization fluid (112) and gas (118) are combined.

In some embodiments, the shearing device (126) may be selected from the group consisting of: a static inline mixer, a cavitation tube, a cavitation nozzle, and a chaos mixer, without limitation.

A sparger (119) for a separator device (100) according to the above description(s) may be provided, advertised, offered for sale, sold, fabricated, imported, exported, and/or shipped, without limitation.

A method for separating particles within an incoming slurry (113) is further disclosed. As suggested by FIG. 16, the method may comprise the step of providing the separator device (100) described above. The method may include the step of combining a gas (118) with a fluidization fluid (112). The method may include the step of shearing the combined gas (118) and fluidization fluid (112) a first time, for example, using a shearing device (126) to produce a first sheared aerated fluid. The method may include the step of passing the first sheared aerated fluid through the sparger (119). The method may include the step of shearing the first sheared aerated fluid a second time through openings or perforations extending through the flexible perforated membrane of the sparger (119) to produce a twice-sheared aerated fluid. The method may include the step of uniformly distributing fine bubbles within the twice-sheared aerated fluid into or throughout the separation chamber (107) of the separator device (100). The method may include the step of segregating particles within the separation chamber (107) based on their size, density, hydrophobicity, or mineral composition (e.g., using the fine bubbles described above). The method may include the step of removing the segregated particles via the launder (117) and lower outlet (109).

In some embodiments, the method may comprise the step of intermittently or periodically boosting the pressure of the first sheared aerated fluid provided to the sparger (119). This step may be advantageously utilized to periodically purge blockages or occlusions within openings or perforations of the flexible perforated membrane structures, without limitation. Flowrate of the first sheared aerated fluid provided to the sparger(s) (119) may also be temporarily increased to provide a purging cycle functionality, without limitation. In some embodiments, the method may comprise expanding or flexing portions of the flexible perforated membrane by virtue of boosting the pressure and/or flowrate to the spargers (119), without limitation.

The method may include the step of allowing the openings or perforations extending through the flexible perforated membrane of the sparger (119) to temporarily expand (i.e., by elastic deformation), thus allowing the first sheared aerated fluid provided to the sparger (119) to pass therethrough at an elevated velocity and/or energy, without limitation. The method may include the step of clearing obstructions or dislodging one or more particles from the openings or perforations extending through the flexible perforated membrane of the sparger (119) by virtue of the elevated velocity and/or energy, and/or by virtue of expansion of the openings or perforations extending through the flexible perforated membrane of the sparger (119). After purging, the pressure (and/or flowrate) of the first sheared aerated fluid provided to the sparger (119) may be reduced to normal operating conditions, wherein the flexible perforated membrane structure returns to a normal configuration having smaller openings and/or perforations therein.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures. It will be appreciated from the drawings that some of FIGS. 1-16 may intentionally omit features or hide components for clarity and/or better visualization and understanding of the invention. Moreover, for clarity, where there are a plurality of similar features in a particular figure, only one of the features may be labelled with reference numerals.

FIG. 1 is a side cutaway schematic representation of a conventional separator device 1.

FIG. 2 is an isometric representative view illustrating another commercially-available separator device 1 according to the prior art.

FIG. 3 is a side cutaway view of the separator device 1 shown in FIG. 2.

FIG. 4 shows a schematic side view representation of aerated fluidization fluid distribution means according to one embodiment of the invention, without limitation. The embodiment shown involves the use of a single tube or pipe comprised of a flexible perforated membrane which is coiled and placed above or affixed to an optionally-perforated panel 111 defining the bottom of a separation chamber 107. Both ends of the single tube or pipe may be fed with aerated fluidization fluid. Each end of the single tube or pipe may comprise its own source of aerated fluidization fluid. Each source of aerated fluidization fluid may comprise its own means 122 for combining a gas and liquid together in a predetermined ratio and pre-shearing the mixture (e.g., via a static inline mixer).

FIG. 5 shows a schematic side view representation of aerated fluidization fluid distribution means according to an alternative embodiment of the invention to the one shown in FIG. 4, wherein both ends of the single tube or pipe may be fed with aerated fluidization fluid from the same (or a single) source. The source of aerated fluidization fluid may comprise means 122 for combining a gas and liquid together in a predetermined ratio and pre-shearing the mixture (e.g., via a static inline mixer). The once-sheared mixture may be split and delivered to each end of the single tube or pipe.

FIG. 6 shows a schematic side view representation of aerated fluidization fluid distribution means according to yet another embodiment of the invention, without limitation. The embodiment shown involves the use of a plurality of nested tubes or pipes—each being comprised of a flexible perforated membrane which is curved and placed above or affixed to an optionally-perforated panel 111 defining the bottom of a separation chamber 107 and/or a top of a fluidization fluid distribution chamber 8. One end of each tube or pipe may comprise a free end which is closed, and the other end of each tube or pipe may comprise an open free end which is fed with aerated fluidization fluid. Each free open end may comprise its own source of aerated fluidization fluid. Each source of aerated fluidization fluid may comprise its own means 122 for combining a gas and liquid together in a predetermined ratio and pre-shearing the mixture (e.g., via a static inline mixer). The plurality of nested tubes or pipes may be arranged, oriented, and/or configured within a lower separation chamber 107 such that they can provide a uniform distribution of bubbles within the separation chamber 107 with few or no hot spots, dead zones, or volumetric regions devoid of bubbles or bubbly mixtures.

FIG. 7 depicts an embodiment similar to that which is shown in FIG. 6, wherein each end of the plurality of nested tubes or pipes may comprise a free open end which is fed with aerated fluidization fluid. As shown, each free open end may be fed with a different source of pre-sheared aerated fluidization fluid.

FIGS. 8 & 9 depict another embodiment wherein a plurality of pucks or discs can be affixed to an optionally-perforated panel 111 defining the bottom of a separation chamber 107 and/or a top of a fluidization fluid distribution chamber 8. Each of the pucks or discs may comprise an upper flexible perforated membrane structure having openings/perforations and may be configured to receive a pre-sheared aerated mixture of fluidization fluid and a gas (e.g., air). As the pre-sheared aerated fluidization fluid enters the pucks or discs under pressure, it is sheared again as it passes through the flexible perforated membrane structures before entering into a separation chamber 107. The plurality of pucks or discs may be arranged, oriented, and/or configured within a lower separation chamber 107 such that they provide a uniform distribution of bubbles within the separation chamber 107 with few or no hot spots, dead zones, or volumetric regions devoid of bubbles or bubbly mixtures. As shown, pucks or discs may share a source of pre-sheared aerated fluidization fluid. However, while not shown, it should be appreciated that each puck or disc may be fed by its own source of pre-sheared aerated fluidization fluid, similar to the embodiment depicted in FIG. 6.

FIGS. 10 & 11 depict another embodiment wherein a panel or plate can be affixed to each section of an optionally-perforated panel 111 defining the bottom of a separation chamber 107 and/or a top of a fluidization fluid distribution chamber 8. Each of the panels or plates may comprise an upper flexible perforated membrane structure and may be configured to receive a pre-sheared aerated mixture of fluidization fluid and a gas (e.g., air). As the pre-sheared aerated fluidization fluid enters the panels or plates under pressure, it is sheared again as it passes through their flexible perforated membrane structures before entering into a separation chamber 107. The plurality of panels or plates may be arranged, oriented, and/or configured within a lower separation chamber 107 such that they provide a uniform distribution of bubbles within the separation chamber 107 with few or no hot spots, dead zones, or volumetric regions devoid of bubbles or bubbly mixtures. As shown, each panel or plate may have its own source of pre-sheared aerated fluidization fluid. However, while not shown, it should be appreciated that similar to the embodiment shown in FIGS. 8 & 9, a plurality of panels or plates may receive pre-sheared aerated fluidization fluid from a shared source.

FIG. 12 is an alternative embodiment suggesting that a plurality of straight flexible perforated membrane sparger tubes may be provided within a separation chamber 107 of a separator device 100. The tubes may be closed at their distal ends. The distal ends may comprise the same flexible perforated membrane material used to define other surfaces of the tubes, or they may be capped with a non-perforated material. The tubes may each be fed with a separate and independent source of pre-sheared aerated fluidization fluid, or, as shown, may share a common source of pre-sheared aerated fluidization fluid. A circular manifold may externally surround the separation chamber 107 and feed pre-sheared aerated fluidization fluid to each of the straight flexible perforated membrane sparger tubes. As shown, the sparger tubes may be inclined to follow an angle (e.g., a sloped frustoconical surface angle) of an optionally-perforated panel 111 defining the bottom of a separation chamber 107 and/or a top of a fluidization fluid distribution chamber 8. Moreover, as depicted, the lengths of adjacent tubes may vary or alternate to provide maximum uniformity of bubbles within the separation chamber 107. In this regard, the tubes are preferably sized, shaped, configured, and/or oriented to provide uniform distribution of bubbles within the separation chamber 107 with few or no hot spots, dead zones, or volumetric regions devoid of bubbles or bubbly mixtures. The tank wall 103 defining an outer boundary of the separation chamber 107 may be provided with means for extracting or inserting the tubes for periodic servicing, without limitation.

FIG. 13 shows an alternative embodiment to FIG. 12, wherein tubes may be oriented to extend radially-inwardly into a lower region of separation chamber 107 without being inclined to follow an angle of an optionally-perforated panel 111 defining the bottom of a separation chamber 107 and/or a top of a fluidization fluid distribution chamber 8. For example, membrane spargers 119 configured as tubes may extend generally horizontally and/or transversely or perpendicular with respect to the tank wall 103. While not shown, it is also anticipated that the embodiments shown in FIGS. 12 and 13 could be combined to have an upper horizontally-disposed set of tubes (as suggested by FIG. 13), and a lower inclined set of tubes (as suggested by FIG. 12) to define multiple bubbly zones within a lower region of separation chamber 107. It is also envisaged that the tubes shown in FIG. 3 may have alternating shapes and/or sizes as suggested by FIGS. 12 and 14, without limitation.

FIG. 14 schematically illustrates a top plan view cutaway of FIG. 12 showing how adjacent tubes may comprise different lengths (e.g., in a predetermined alternating fashion) to maximize coverage and/or provide optimal uniformity of bubble distribution within the separation chamber 107. Thus, rather than the nested or coiled configurations of FIGS. 4-7, or the puck or panel configurations of FIGS. 8-11, tubes may be more easily extracted from the separation chamber 107 by radial outward extraction through tank wall 103, whilst still providing a configuration of flexible perforated membrane spargers which provide uniform distribution of bubbles within the separation chamber 107 with few or no hot spots, dead zones, or volumetric regions devoid of bubbles or bubbly mixtures. As shown, one or more (i.e., a plurality of) sources of pre-sheared aerated fluidization fluid may be used to feed an outer annular manifold that, in turn, feeds a plurality of tubes provided within the separation chamber 107.

FIG. 15 schematically illustrates one non-limiting example of how a flexible perforated membrane sparger tube 119 may be provided within a separation chamber 107 and secured to a tank wall 103. A sparger feed device 130 may independently receive feeds of a gas (e.g., pressurized air) and fluidization fluid via respective first 131 and second 132 inlets. The combined liquid/gas mixture may pass through a shearing device 126 (e.g., inline static mixer, cavitation tube, or other shearing device) integrally-provided within the sparger feed device 130. The sparger feed device may be mountable (e.g., by thread, bolted flange, or other known mechanical connecting means 128) to the tank wall 103 defining the outer boundary of the separation chamber 107. Shown, is an NPT-style thread that is received by a complimentary NPT-style female thread within tank wall 103. Downstream of the shearing device 126 and fluidly communicating with the sparger feed device 130, a flexible perforated membrane sparger tube 119 may be provided, wherein the sparger tube extends into the separation chamber 107. As shown, the sparger tube may comprise a free end and may extend into the separation chamber 107 such that its free end is located proximate or adjacent to a central region of the separation chamber 107, as shown. However, it is envisaged that (while not shown), the sparger tube may extend across the entire diameter of the separation chamber 107. Moreover, while not shown, the sparger tube may have two open ends which are each fed by its own respective juxtaposed or diametrically-oppositely arranged sparger feed devices mounted to tank wall 103, without limitation. To extract the sparger tube 119, the sparger feed device 130 is decoupled or removed from the tank wall 103, and the sparger tube 119 is pulled through an opening through the tank wall 103.

FIG. 16 suggests a method which may be practiced in accordance with preferred embodiments of the invention. The method is unique in that involves the use of a flexible perforated membrane structure to deliver aerated fluidization fluid to a separation chamber 107. Moreover, the method may be considered unique in that it may involve a two-step shearing process wherein a gas and liquid can be combined and then first-sheared (e.g., using an inline static mixer or other shearing device), and then feeding the once-sheared bubbly mixture through openings or perforations of a flexible perforated membrane structure under pressure to twice-shear the once-sheared bubbly mixture before it enters into the separation chamber 107. This dual-shearing of aerated fluidization fluid creates a more even and uniform, tight distribution of very fine bubbles 129 within the separation chamber 107.

FIGS. 17 & 18 suggest that an upper segment 133, middle segment 134, and lower segment 135 may collectively form a tank wall 103 of a separator device 100, according to some embodiments. The middle segment 134 preferably comprises an aeration segment 136 (such as the one depicted in FIG. 17). The aeration insert 136 preferably has one or more flexible perforated membrane spargers 119 provided thereto. If/when the spargers 119 become clogged or need servicing, they can be individually removed or replaced. Alternatively, the entire middle segment 134 may be removed and replaced (e.g., with another aeration insert 136).

FIG. 19 shows a cross-sectional view of an exemplary, non-limiting embodiment of a flexible perforated membrane sparger 119 installed on an aeration insert 136, such as the one depicted in FIG. 17. The aeration insert 136 is preferably designed to be used as a middle segment 134 in a separator device 100. The flexible perforated membrane sparger 119 shown may be used in other embodiments (depicted and not depicted), without limitation.

FIG. 20 is an isometric view of the cross-sectional view shown in FIG. 19.

FIG. 21 is a non-cutaway view of the flexible perforated membrane sparger 119 depicted in FIGS. 19 and 20.

FIG. 22 is an exploded view showing how the flexible perforated membrane sparger 119 may be assembled to an inlet flange 140 of an annular body 139.

FIG. 23 suggest a method of swapping middle segments 134 of a separator device 100. The method may involve removing an aeration insert 136 from a separator device, and replacing it with a standby aeration insert 136. In this regard, the removed aeration insert 136 can be refurbished, cleaned, or serviced while the separator device 100 is quickly re-assembled and re-commissioned for operation.

### DETAILED DESCRIPTION OF THE DRAWINGS

A separator device 100 may comprise a tank wall 103 defining a (main) separation chamber 107. A slurry inlet 102 configured to introduce incoming slurry 113 to the separation chamber 107 may extend from an upper portion of the tank wall 103. In some embodiments, the tank wall 103 may be defined from one or more portions of an upper segment 133, a middle segment 134, and a lower segment 135, without limitation. The slurry inlet 102 may fluidly communicate with the separation chamber 107.

The bottom of the separation chamber 107 may be delineated by a fluidization fluid panel 111, which may be optionally perforated, should an optional fluidization fluid distribution chamber 108 be provided to the separator device 100 below the separation chamber 107. The central region of the fluidization fluid panel 111 may give way to a centrally located lower outlet 109 which is configured to allow solids to pass through the fluidization fluid panel 111 and remove them as underflow 114 from the separator device 100 as depicted.

If a fluidization fluid distribution chamber 108 is provided to the separator device 100 (e.g., below separation chamber 107), a fluidization fluid inlet 104 may be provided to deliver incoming fluidization fluid 112 with optional air or gas 118 therein. Moreover, the fluidization fluid panel 111 may comprise a number of optional openings 110 (e.g., perforations, slots, orifices, or nozzles) therein to convey fluidization fluid 112 and optional air or gas 118 through the fluidization fluid panel 111 and into the separation chamber 107, without limitation.

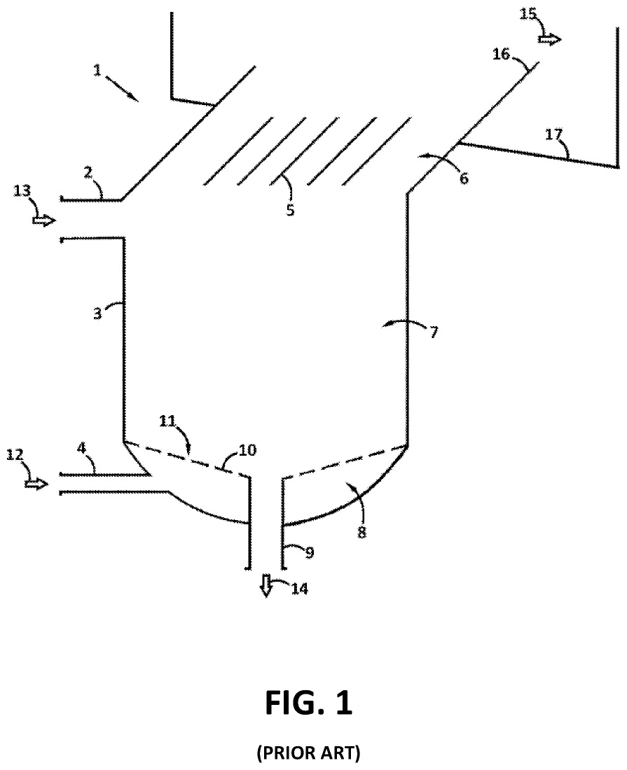

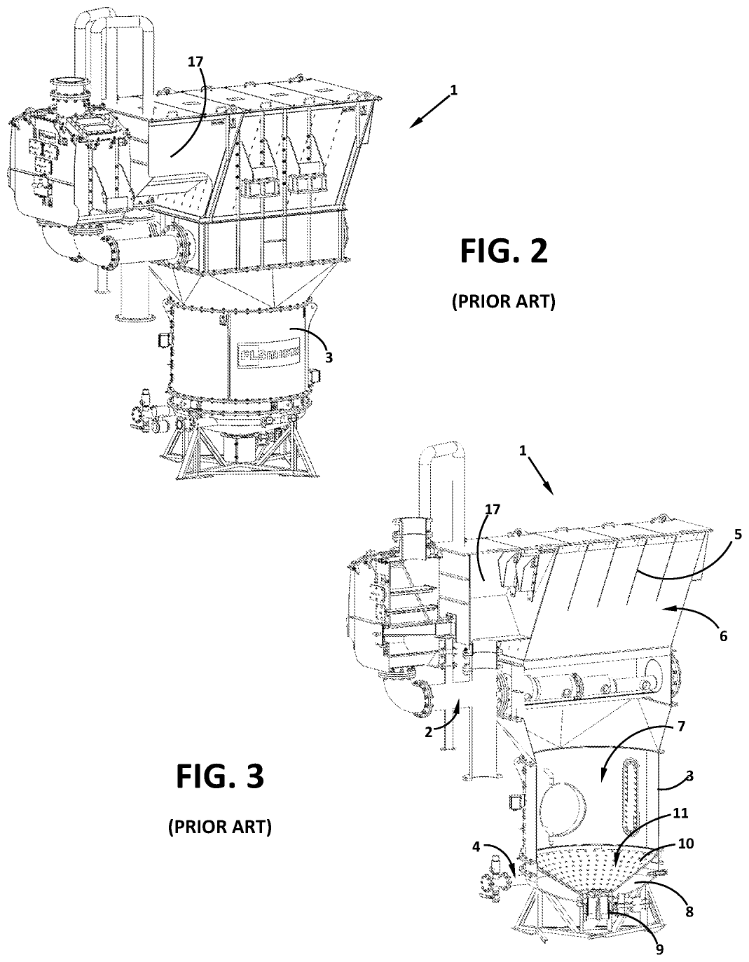

An upper separation chamber 106 may be provided above the separation chamber 107. As shown in FIGS. 1 and 3, the upper separation chamber 106 may be provided with a number of spaced lamellae or inclined channels, for example, a stack of generally-inclined parallel plates 5, without limitation.

According to preferred embodiments, a flexible perforated membrane sparger 119 comprising a flexible perforated membrane structure may be provided. One or more flexible perforated membrane spargers 119 may be provided within the separation chamber 107, above the fluidization fluid panel 111, in order to economically distribute fine bubbles within the separation chamber 107 during operation. Means 122 for supplying pre-sheared aerated fluidization fluid to the flexible perforated membrane sparger 119 may be provided, such that during operation, the flexible perforated membrane sparger 119 may receive pre-sheared aerated fluidization fluid under pressure and the same may pass through the openings or perforations within the flexible perforated membrane structure of the sparger 119, thus twice-shearing the received aerated fluidization fluid before it enters into the separation chamber 107.

Said differently, a first shearing of the aerated fluidization fluid mixture of fluidization fluid 112 and air or gas 118 may be performed by the shearing device 126, and a second shearing of the first-sheared mixture leaving the shearing device 126 may be performed such that the first-sheared mixture is sheared a second time as it passes through the openings or perforations within the flexible perforated membrane structure of the sparger 119.

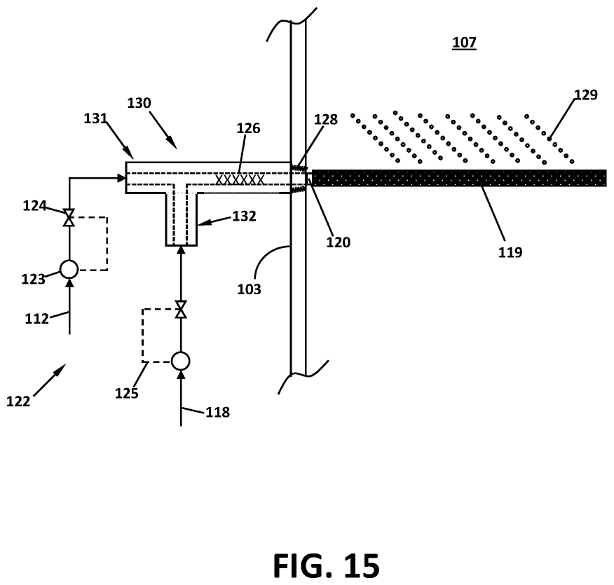

Air or gas 118 may be pre-mixed with incoming fluidization fluid 112 and then be pre-sheared using a shearing device 126 (e.g., an inline static mixer, a cavitation tube, a cavitation nozzle, a chaos mixer, or the like, without limitation). As will be appreciated from FIG. 15, means for mixing the fluidization fluid 112 and air/gas, and means 126 for shearing the same may be advantageously provided in a single device, such as a sparger feed device 130, without limitation. A plurality of sparger feed devices 130 may be provided at outer circumferential locations about a periphery of tank wall 103 as shown, without limitation.

A sparger feed device 130 may be provided with a first inlet 131 for receiving a flow of fluidization fluid 112, and a second inlet 132 for receiving a flow of air or gas 118. The fluid 112 and air or gas 118 may be combined within the device 130 and passed through an internal shear device 126. A portion of the sparger feed device 130 may comprise connecting means 128, such as a threaded outer diameter or mounting flange having bolt holes for connecting the sparger feed device 130 to the tank wall 103 of the separator device 100. The sparger feed device 130 is preferably provided adjacent a lower outer region of the separation chamber 107. Downstream of the internal shearing device 126 may be a main feed line 120 that delivers pre-sheared aerated fluidization fluid to a flexible perforated membrane sparger 119 provided in the form of an extractable straight tube. The tube may comprise a free end that remains cantilevered and suspended within a region of the separation chamber 107. The sparger feed device 130 may be removed from the tank wall 103 by disengaging the connecting means 128 from the tank wall 103 and laterally extracting both the sparger feed device 130 and flexible perforated membrane sparger 119 from the separator device 107 together, without limitation.

Pre-sheared aerated fluidization fluid may pass from the shearing device 126 to a main feed line 120. The main feed line 120 may, in some embodiments, serve to directly feed a flexible perforated membrane sparger 119 located within the separation chamber 107. In some embodiments, the main feed line 120 may serve to feed a manifold 121 which indirectly feeds a number of flexible perforated membrane spargers 119. For example, as depicted in FIGS. 9 & 12-14, the manifold 121 may serve to distribute pre-sheared aerated fluidization fluid to a number of branch feed lines 127. When employed, each of the branch feed lines 127 may serve to feed one or more flexible perforated membrane spargers 119.

Pre-sheared aerated fluidization fluid delivered to a flexible perforated membrane sparger 119 may be optimized by providing a flow indicative transmitter (FIT) 123 and a control valve 124 at each respective source of incoming fluidization fluid 112 and incoming air or gas 118, as depicted. The flow indicative transmitters 123 can measure respective amounts of incoming fluidization fluid 112 and air or gas 118, and may be used to monitor and/or control ratios of each prior to mixing in the shearing device 126. For example, a flow indicative transmitter 123 may send one or more control signals 125, to a control valve 124 to independently restrict or increase flow of fluidization fluid 112 or air/gas 118 to shearing device 126. In this regard, a ratio of fluidization fluid 112 and air or gas 118 can be controlled or adjusted, as needed, prior to entering the shearing device 126.

Embodiments of the unique flexible perforated membrane spargers 119 disclosed herein are preferably configured to discharge microbubbles 129 within the separator chamber 107. By virtue of providing twice-sheared aerated fluidization fluid, bubble sizes may be optimized for separations and may demonstrate improved performance in certain separations such as classification by mineralogy by flotation.

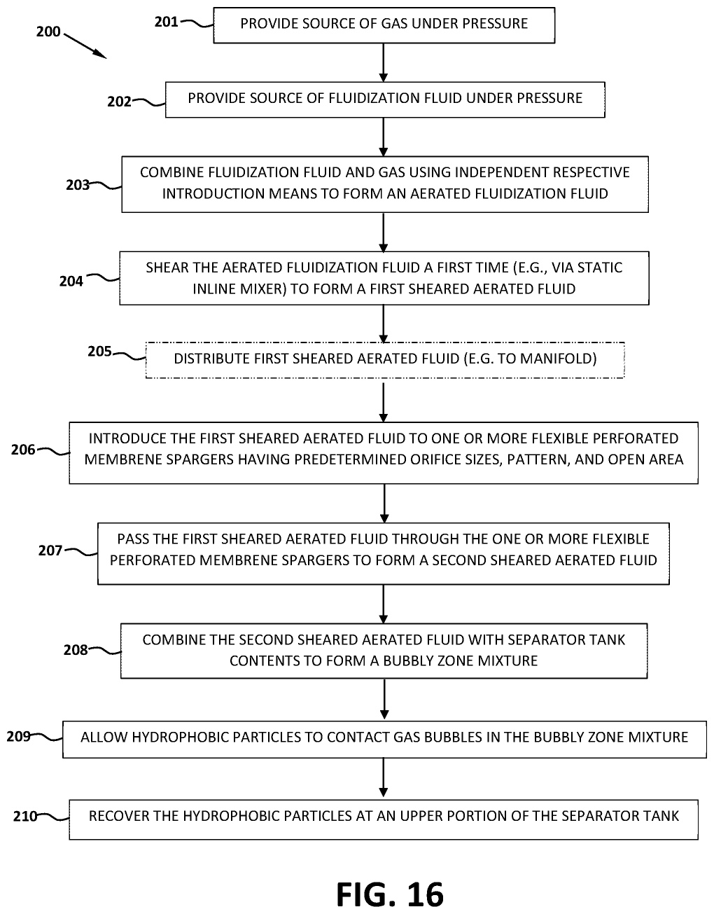

FIG. 16 suggests a method 200 of twice-shearing a pre-aerated mixture of air or gas 118 and fluidization fluid 112. One or more of the following steps 201-210 may be involved in the method 200. A source of gas under pressure, such as compressed air, may be provided. A source of fluidization fluid under pressure may also be provided. The gas and fluidization fluid may be received from independent sources, e.g., each source comprising a control valve 124 and flow indicative transmitter 123. An aerated fluidization fluid may be formed by combining the gas 118 and fluidization fluid 112. The aerated fluidization fluid may then be sheared a first time (i.e., “pre-sheared”) using shearing means such as a shearing device 126 to form a first-sheared aerated fluid. This fluid may be delivered to a manifold or directly to one or more of the flexible perforated membrane spargers 119 described herein. The first-sheared aerated fluid may be passed through the flexible perforated membrane spargers and be sheared, once again, by virtue of passing through openings or perforations in a flexible perforated membrane structure of each sparger 119. Thus, a twice-sheared, or double-sheared aerated mixture of fluidization fluid and gas may be delivered to the separation chamber 107, in turn, providing a controlled and uniform distribution of microbubbles 129 to one or more lower regions of the separation chamber 107. The resulting twice-sheared, or double-sheared aerated mixture of fluidization fluid and gas introduced to the separation chamber 107 may combine with other contents within the separation chamber 107, to form or enhance a bubbly mixture zone. For purposes where the separator device 100 is used for flotation purposes (e.g., coarse particle froth flotation in minerals processing circuits), these microbubbles 129 may be contacted with hydrophobic particles in the separation chamber 107 (said particles being derived from the incoming feed slurry 113), and rise upward within the separation chamber 107. Ultimately, the hydrophobic particles attached to these microbubbles 129 may be recovered at an upper end of the unit (e.g., via launder 117) e.g., after passing through upper separation chamber 106.

At any point in time, should openings or perforations within flexible perforated membrane structures of one or more of the spargers 119 become occluded, blocked, or clogged by particles within the separation chamber 107, an intermittent or periodic purge cycle may take place wherein control valves 124 may be opened to allow a greater amount of pre-sheared aerated fluidization fluid therein. Alternatively, a temporary boost in pressure of the incoming fluidization fluid 112 or gas 118 sources may be initiated (manually or via a control system) to the holding tanks thereof.

Blockages of openings or perforations within flexible perforated membrane structures of one or more of the spargers 119 may be determined by continuously or periodically monitoring outflows 14, 15 of the separator device 100 and/or by continuously or periodically monitoring flowrates using the flow indicative transmitters 123. In cases where there is little or no change in outflows 14, 15, or a reduction in outflow 14, 15 with increasingly greater required inflows of fluidization fluid 112 or gas 118, a blockage of flexible perforated membrane structure may be inferred, and a boost overpressure purging cycle may be warranted.

Since the unique spargers 119 described herein (and depicted in the accompanying drawings) preferably incorporate a flexible perforated membrane structure, any occlusions, blockages, or clogging of openings or perforations in the flexible perforated membrane structures of the spargers 119 may be remedied by supplying an intermittent temporary increase in pressure or flow of pre-sheared aerated fluidization fluid. By increasing pressure or flow to each sparger 119, the flexible perforated membrane structure may stretch, expand, increase in surface area, or elastically deform, such that its openings or perforations may temporarily increase in size and allow a pre-sheared aerated fluidization fluid at increased velocities through them to encourage removal of particles that might be stuck within the openings or perforations.

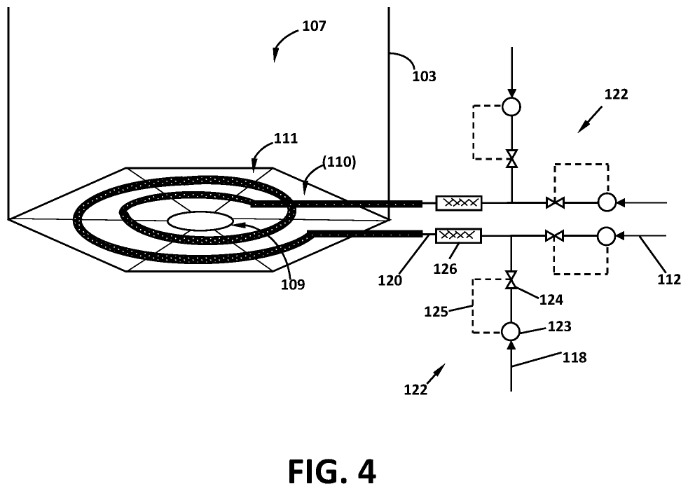

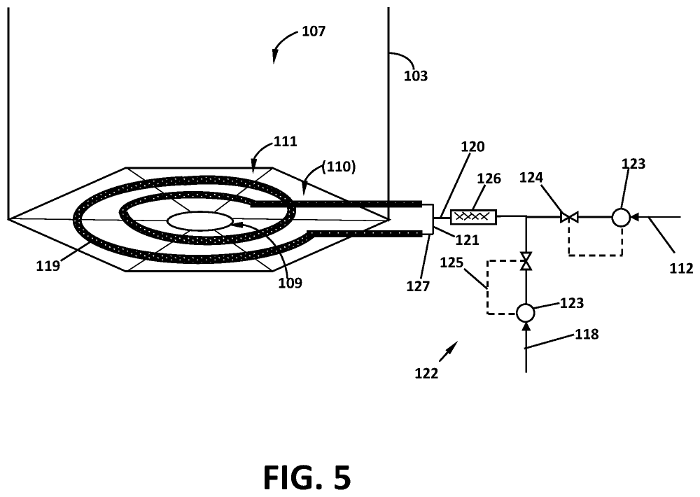

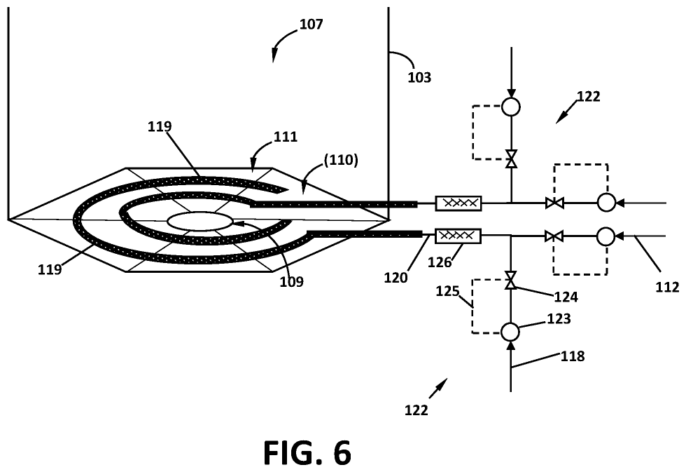

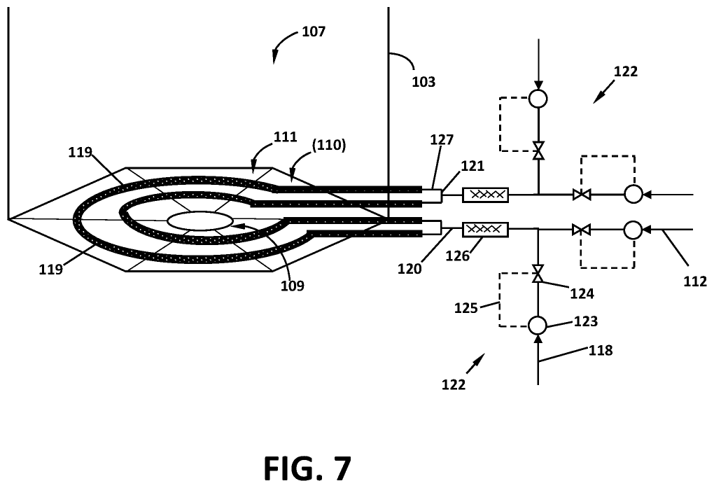

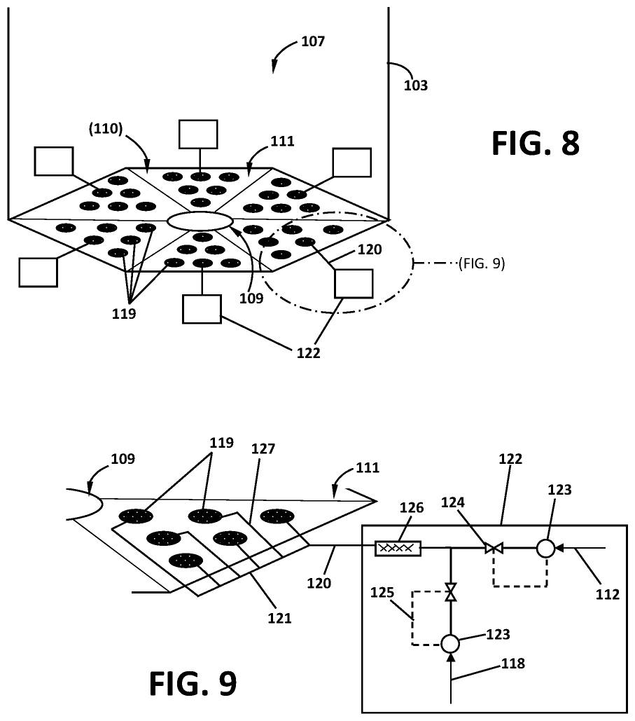

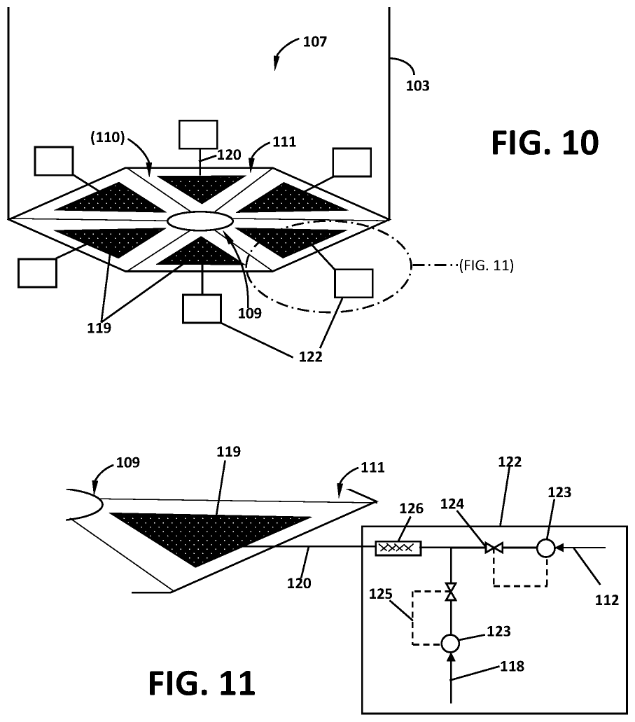

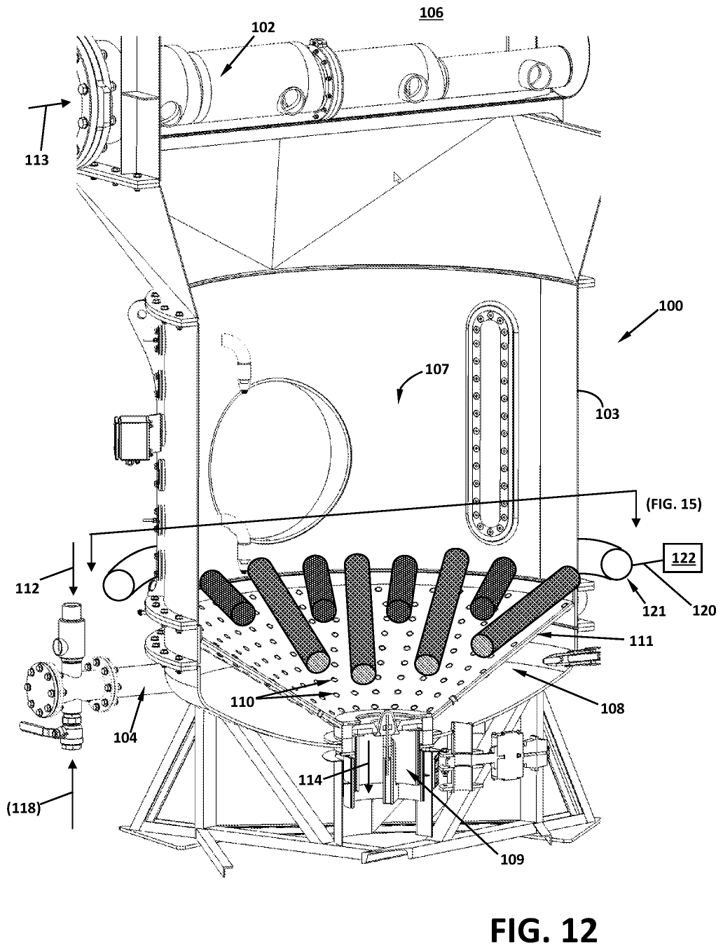

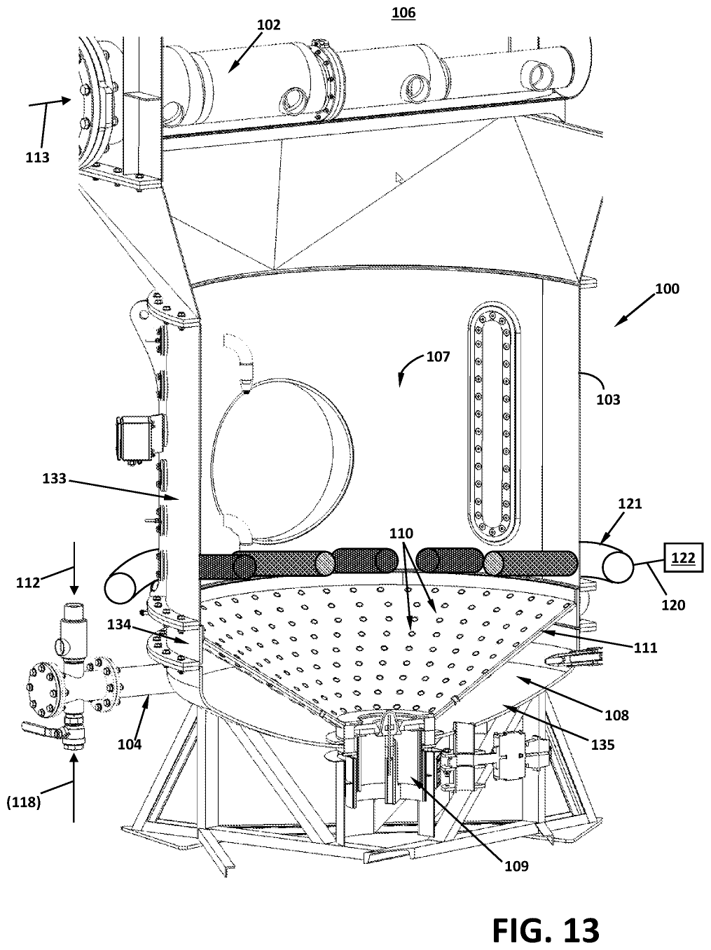

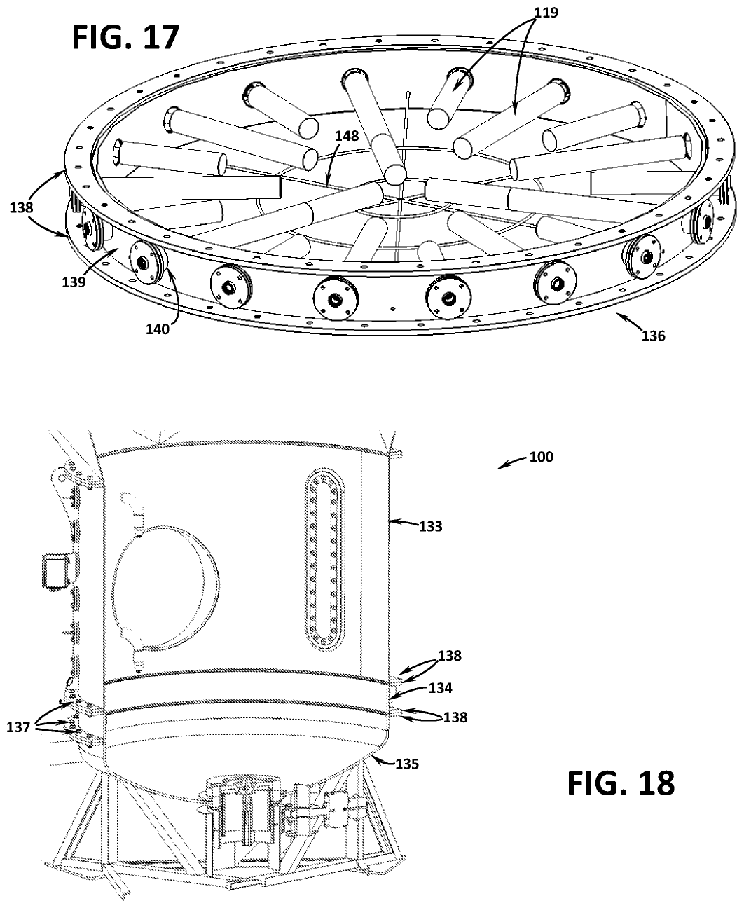

Turning now to FIGS. 17 & 18, a tank wall 103 of a separator device 100 may be defined at least partially by a middle segment 134, and at least one of an upper segment 133 and a lower segment 135. As shown, an upper 133, middle 134, and lower 135 segment may collectively form the tank wall 103, without limitation. The middle segment 14 may be located between an upper segment 133 and a lower segment 135 as shown. The middle segment 134 may preferably comprise an aeration insert 136 such as the one depicted in FIG. 17. The aeration insert 136 may comprise a number of flexible perforated membrane spargers 119, such as the radially-extending tubular ones shown in FIG. 17. It should be understood that substantially flat, substantially planar, substantially disc-shaped, annular, or spiral shaped spargers 119 may be employed (e.g., similar to those depicted in FIGS. 4-11). The spargers 119 may extend inwardly from an annular body 139 as depicted. The annular body 139 may comprise upper and/or lower flanges 138 comprising holes 147 for receiving fasteners 137 therethrough.

One or a plurality of the aeration inserts 136 depicted in FIG. 17 may be introduced between the upper 133 and lower 135 segments depicted in FIG. 18, and secured thereto (e.g., by bolts, nuts, or equivalent fasteners 137 through holes 147 of respective flanges 138) to serve as a middle segment 134 of the separator device 100. A separator device 100 “system” may be provided, wherein the system comprises an upper segment 133, a lower segment 135, and one (or more) aeration insert(s) 136 secured between the upper 133 and lower 135 segments and collectively serving as a middle segment 134 portion of a separator device 100 within the system. If a plurality of aeration inserts 136 are used as a middle segment 134, they may comprise similar or different configurations of spargers 119, without limitation.

The separator device 100 system may further comprise one or more “backup”, “standby” or “replacement” aeration inserts 136, which may be reserved for standby use, future installation, and/or spare parts for servicing a middle segment 134 of the separator device 100.

If/when the separator device 100 of the system experiences fouling of flexible perforated membrane spargers 119 of one or more of the installed aeration inserts 136, the middle segment 134 may be disassembled/detached from the upper 133 and lower 135 sections (e.g., by unbolting at flanges 138), and may be removed from the separator device 100. The one or more backup, standby, or replacement aeration inserts 136 of the system may then be installed and secured between the upper 133 and lower 135 segments (e.g., by tightening bolts 137 at respective flanges 138), and serve as a new middle segment 134 of the separator device 100. In this regard, removed aeration section(s) 136 may be serviced, cleaned, and/or have their flexible perforated membrane spargers 119 removed and replaced with new flexible perforated membrane spargers 119, while the separator device 100 operates. Thus, a separator device 100 system may be configured to achieve reduced separator device 100 downtime and minimize operating expenditures (OPEX) associated with extended periods of non-operation. By providing one or more backup, standby, or replacement aeration inserts 136, the middle segment 134 of the separator device 100 may be readily swapped in and out of the separator device 100 in a quick and convenient manner, and enable the separator device 100 to resume operation in a short amount of time.

As can be seen from FIG. 17, an optional catchment device 148, such as a net structure, cage structure, web structure, grate structure, grid structure, or the like may be provided below the spargers 119 and/or may extend across portions or the entirety of the annular body 139 of an aeration insert 136. The catchment device 148 may be designed and/or configured to allow fluids to pass across it, but catch any fallen or broken components of spargers 119. In this regard, when used as a removable middle segment 134 of a separator device 100, the aeration insert 136 can be removed from upper 133 and/or lower 135 segments along with any debris which may have been caught by the catchment device 148.

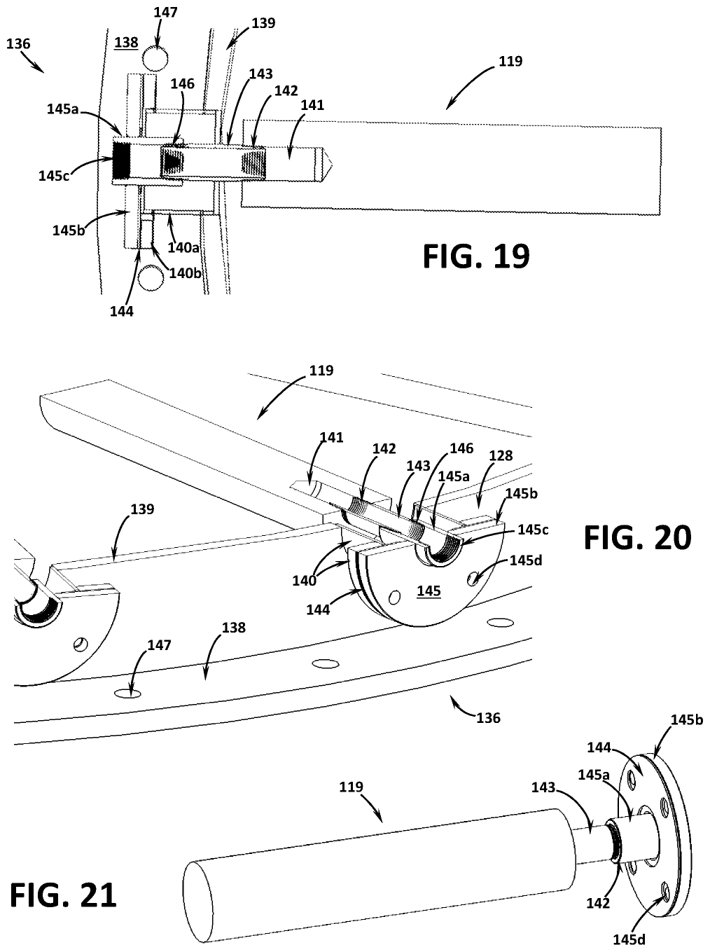

FIG. 19 shows a cross-sectional view of an exemplary, non-limiting embodiment of a flexible perforated membrane sparger 119 installed on an exemplary aeration insert 136 (such as the one depicted in FIG. 17). The aeration insert 136 is preferably designed to be used as a middle segment 134 in a separator device 100 (e.g., in a manner similar to what is described above). The flexible perforated membrane sparger 119 shown may be used in other embodiments, without limitation.

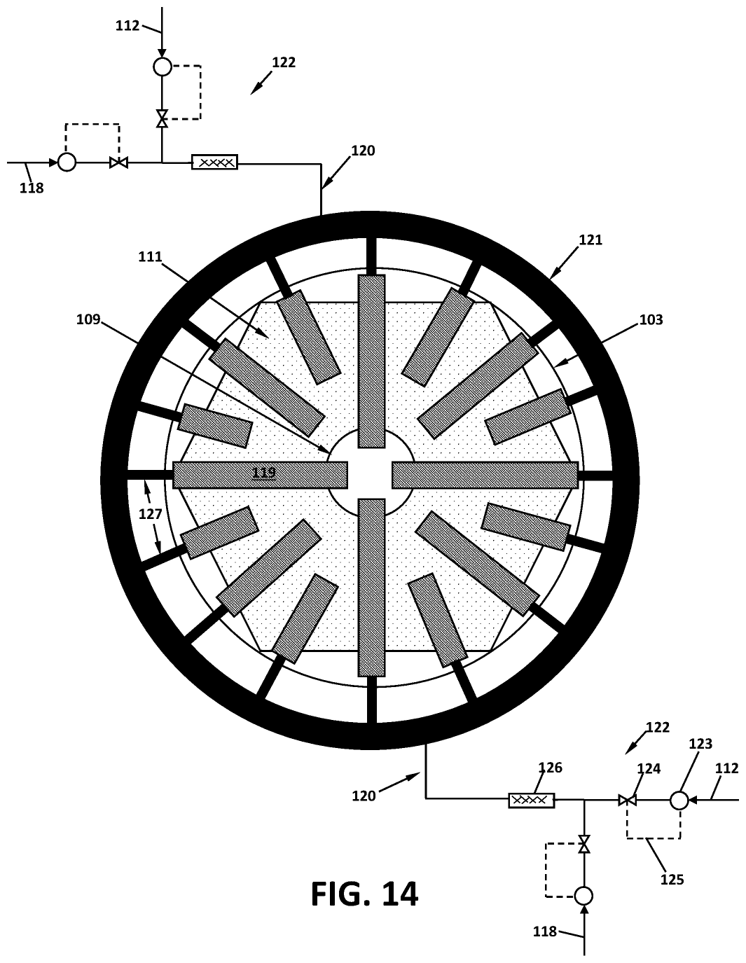

In the particular embodiment shown, the flexible perforated membrane sparger 119 may comprise an elongated tubular flexible perforated membrane structure which forms a chamber or cavity designed to receive gaseous liquid. The gaseous liquid may be formed by mixing a liquid fluid 112 with a gas fluid 118 (e.g., in any of the manners suggested by FIGS. 4-7, 9, 11, 14, and 15, without limitation).

The tubular flexible perforated membrane structure may comprise a receiving portion 141 for accepting a first threaded end 142 of a pipe connector 143, without limitation. The receiving portion 141 may comprise a threaded surface for threaded engagement with the first threaded end 142 of the pipe connector 143, without limitation. The threaded engagement may comprise a conventional NPT-style fitting, without limitation.

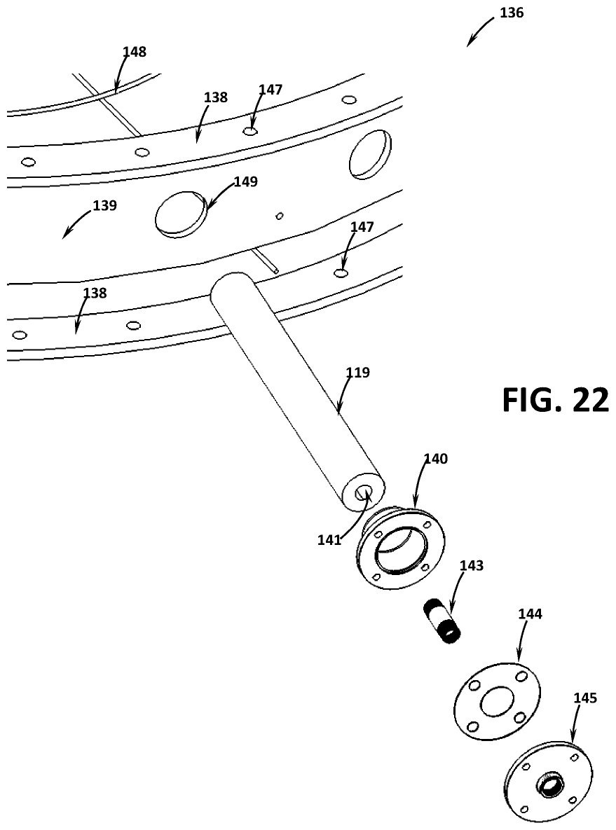

A second threaded end 146 of the pipe connector 143 may threadedly engage a tubular body portion 145a of an endcap 145. The endcap 145 may comprise a flange portion 145b integrally-connected with and/or supporting the tubular body portion 145a as depicted. An inlet flange 140 comprising a tubular portion 140a and a flange portion 140b may extend from the annular body 139 of the aeration insert 136. The tubular portion 140a may be permanently or removably affixed to the body 139. For example, the tubular portion 140a of the inlet flange 140 may be welded or screwed into an opening 149 of the annular body 139 (this is most clearly seen in FIG. 22).

The flexible perforated membrane sparger 119 may be installed within the aeration insert 136 by inserting it through the inlet flange 145 and opening 149 of the annular body 139. An optional gasket 144 may be placed over the flange portion 140b of the inlet flange prior to insertion of the sparger 119. The flange portion 145b of the endcap 145 may then be secured to the flange portion 140b of the inlet flange 140 by aligning one or more respective through openings 145d extending through the flange portions 140b, 145d, and inserting fasteners through the one or more through openings 145d. The fasteners (not shown for clarity) are preferably bolts and may be secured in traditional fashion, for example, by threading a nut to a threaded distal end of each bolt. Washers (including the locking type) may be used with the fasteners, without limitation. Fasteners comprising self-locking nuts may also be utilized, without limitation.

The endcap 145 may comprise a gaseous liquid inlet hose connecting portion 145c as shown. The gaseous liquid inlet hose connecting portion 145c may comprise a threaded feature or quick-connect hydraulic coupling, without limitation. The gaseous liquid inlet hose connecting portion 145c may be defined in the flange portion 145b of the endcap 145, or may be formed adjacent an end of the tubular body portion 145a. As depicted, the gaseous liquid inlet hose connecting portion 145c may be defined within the tubular body portion 145a of the endcap, although it may be defined on external surfaces thereof. The tubular body portion 145a may extend beyond the flange portion 145b of the endcap 145 as shown, to provide a portion of a hydraulic connector and/or hydraulic connection surface, without limitation.

FIG. 20 is an isometric view of the cross-sectional view shown in FIG. 19. FIG. 21 is a non-cutaway view of the flexible perforated membrane sparger 119 depicted in FIGS. 19 and 20. FIG. 22 is an exploded view showing how the flexible perforated membrane sparger 119 may be assembled to an inlet flange 140 of an annular body 139. These figures are provided for better understanding of the sparger 119 embodiment depicted in FIGS. 17 and 19.

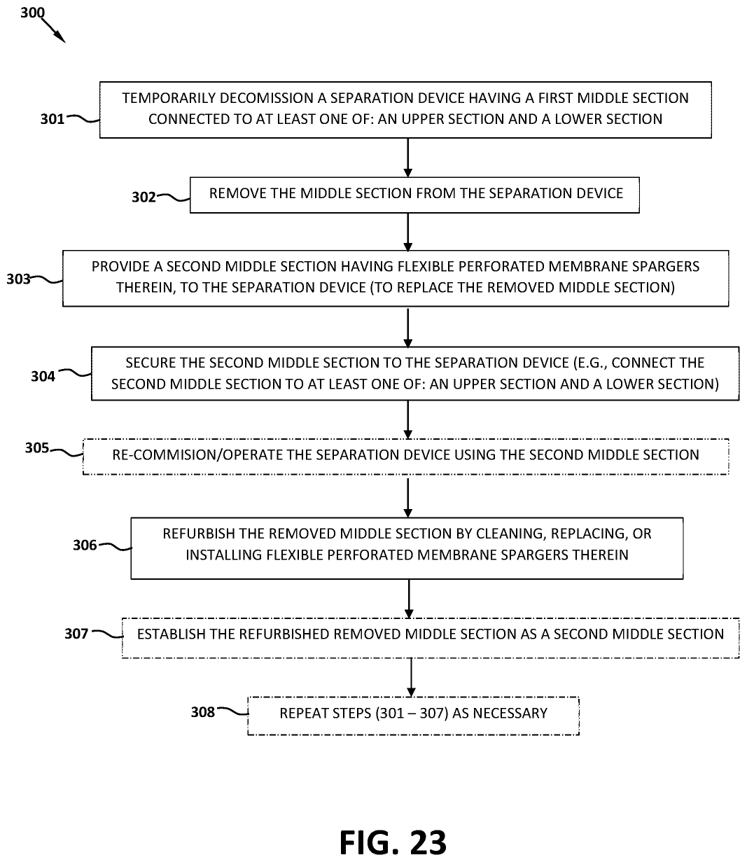

FIG. 23 suggests a method 300 of swapping out a middle segment 134 of a separator device 100 to reduce operational downtime of the separator device 100. The middle segment 134 is preferably an aeration insert 136, such as the one shown in FIG. 17. The method 300 may include one or more steps 301-308 as depicted. For example, the method of temporarily decommissioning 301 a separator device 100. The middle segment 134 of the separator device may be decoupled or detached from an upper 133 and/or lower 135 segment of the separator device 100. The middle segment 134 may then be removed 302 from the separator device 100. A second middle segment 134 may be provided 303 and this second middle segment 134 may be used to replace the removed middle segment 134. The second middle segment 134 may be secured 304 to the upper 133 and/or lower 135 segment(s) of the separator device 100. The separator device 100 may be recommissioned and/or put back into service operation 305 with the second middle segment 134 installed. While the separator device 100 is operating, the removed middle segment 134 can be refurbished 306, or a new middle segment 134 can be ordered for standby use. For example, flexible perforated membrane spargers 119 of the removed middle segment 134 can be cleaned, replaced with new spargers, or otherwise serviced and remain on standby as a second middle segment 134 for future use in the separator device 100. Any one or more of the above steps 301-307 may be repeated 308 as necessary.

The separator device 100 and/or flexible perforated membrane sparger structures 119 described and illustrated herein are provided merely as examples to which the invention of the claims may be applied. The specification does not suggest that the claims are somehow limited to or apply only to the particular embodiments shown and described herein.

Where used herein, the terms “upper segment”, “middle segment”, and “lower segment” may be used interchangeably with the terms “upper section”, “middle section”, and “lower section”, respectively, without limitation. It should be understood that where used herein, the middle segment 134 may be synonymous or used interchangeably with “second middle section”, “second middle segment”, or “aeration insert 136”. The term “aeration insert” has been chosen by the applicant, but it should be understood that this term may be used interchangeably with other terms such as “aeration device”, “aeration segment”, “aeration section”, “aeration insert”, “aeration disc”, “aeration ring”, “aeration portion of the separator device”, or the like, without limitation. It is believed that those skilled in the art would appreciate and anticipate other terms and lexicography could adequately represent the disclosed features.

Where used herein, the terms “gaseous liquid” and “second sheared aerated fluid” may be used interchangeably, without limitation. It should be understood that the spargers 119 described and depicted in FIGS. 17-22 may be configured to receive single or twice-sheared fluidization fluid via a main feed line 120 or manifold 121, without limitation. A combination of gaseous 118 and liquid 112 fluids in any ratio may be provided to any one of the spargers 119 described or depicted herein. It is further anticipated that only liquid 112 fluids, or only gaseous fluids 118 may be provided to one or more of the spargers 119 described or depicted herein. It is further envisaged that for embodiments where a plurality of spargers 119 are used within a separator device 100, one or some of the spargers may receive different gas/liquid ratios. It is further envisaged that one or some of the spargers 119 within a separator device 100 may receive one type of fluid (e.g., gas 118), and another one(s) of the spargers 119 may receive another type of fluid (e.g., liquid 112), without limitation. Moreover, it is further envisaged that for embodiments where a plurality of spargers 119 are used within a separator device 100, one or some of the spargers may receive “once-sheared” gas/liquid combinations, and one or more other spargers 119 within the separator device 100 may receive “twice-sheared” gas/liquid combinations, without limitation.

Where used herein, the term “perforated” or “perforations” may be broadly construed as a membrane having passages in which gas and/or liquid may pass. Thus, a “perforated” membrane, where used herein, may include a sheet (preferably flexible) with one or more slits having substantially zero width, one or more slots with minimal discernible width, one or more pin holes or pin pricks of substantially zero diameter, one or more pin holes or pin pricks with minimal discernible width, small substantially symmetrical openings (e.g., orifices), one or more small elongated openings, or the like, without limitation. For example, in some preferred embodiments, ˜1 mm spaced slits (±0.5 mm) may be applied to a membrane in a preferably uniformly-distributed pattern, with the slits being formed with substantially no discernible width when the membrane is in a relaxed, unstressed, and/or non-flexed state. In some preferred embodiments, approximately 100 of such slits or “perforations” may be provided to the membrane per square inch of membrane, without limitation. It is anticipated that a greater or lesser number of perforations may be provided (e.g., 1 perforation per square inch to as much as 150 perforations per square inch, such as 50-150 perforations per square inch). The material mechanical properties of the membrane (e.g., elastic modulus, elasticity, etc.) may ultimately determine the maximum number of perforations that may be practically provided per square inch of membrane without causing rupture of the membrane due to tearing adjacent the perforations.

In some embodiments, the perforations in the membrane may comprise a combination of one or more of the following, without limitation: slits, pin holes, pin pricks, symmetrical openings, elongated openings. The perforations may be provided in any practical variation, number, combination, or pattern, but are preferably spaced and/or staggered with respect to one another and uniformly-distributed across surface areas of the membrane. In some embodiments, the one or more slits, pin holes, pin pricks, symmetrical openings, and/or elongated openings may appear to be closed in an unstressed membrane state or otherwise form a normally-closed aperture (e.g., when the sparger is in an unpressurized state); wherein upon an application of pressure or fluid flow force to the sparger, the same one or more perforations may open slightly to define an orifice capable of allowing a passage or flow of a fluid such as gas and/or liquid through the membrane, without limitation. In this regard, a flexible perforated membrane sparger as described herein may be configured for (or inherently comprise means for) “backflow prevention”, wherein fluids are able to pass from within the sparger through the perforated flexible membrane structure (via the perforations) and finally to regions surrounding external surface portions the sparger, but wherein solids may not necessarily be able to pass thereinto if the sparger is depressurized or membrane relaxed. By minimizing the open orifice area for the one or more perforations, backflow of solids into the flexible perforated membrane sparger is deterred or substantially inhibited.

### EXAMPLE

To test backflow prevention capability, a flexible perforated membrane sparger of the type described was placed into a closed pipe (chamber) with the sparger inlet open to atmosphere (e.g., thus the inner portions of the flexible perforated membrane sparger were maintained at “atmospheric pressure” during all portions of the test). Slurry was then fed into the closed pipe (chamber) surrounding the flexible perforated membrane sparger in order to surround and pressurize the exterior surfaces of the sparger with the slurry. Pressure in the pipe (chamber) externally acting on surface portions of the sparger was started at 20 psig and then increased by 5 psig for successive intervals. The closed pipe (chamber) was held for 5 minutes at each successive interval of increased slurry pressure. Due to the nature and configuration of the small perforations (i.e., closed ˜1 mm slits), water from the slurry only began to leak back through the flexible perforated membrane and into the sparger body via the perforations at a significant 60 psig pressure level. However, no discernible solids were found to be present within the sparger body at this pressure. The test ceased after reaching a maximum of 60 psig in the pipe (chamber). Accordingly, the inventors have concluded that in the event internal sparger feed pressure drops substantially during operation within a flotation cell (e.g., during interruptions, pump failure, or maintenance cycles), large heads within the cell would be required to begin fouling the internals of the flexible perforated membrane spargers described herein. Thus, the design and configuration of the flexible perforated membrane structures disclosed may demonstrate suitable backflow prevention performance characteristics.

In some embodiments, the one or more slits, pin holes, pin pricks, symmetrical openings, and/or elongated openings defining the “perforations” in the membrane structure of the spargers disclosed herein may be selected to have a maximum opening size width of 1 nanometer to 3 millimeters, or more. For purposes of maintaining fine bubble size distributions and optimal flotation characteristics, the inventors have determined that a maximum opening size width of the perforations (e.g., “slits”) should optimally be maintained at or below approximately 2 millimeters, without limitation.

Where used herein, the term “membrane” may comprise many different materials, including, but not limited to EPDM rubber, silicone rubber, santoprene, gum rubber, natural rubber, neoprene, and/or the like. Thicknesses of the flexible perforated membrane referenced herein may vary, but are preferably greater than 1/16 of an inch (e.g., approximately ⅛″ to ¼″), without limitation.

The above description of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art in light of the above teaching(s). Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, as well as other embodiments that might clearly fall within the spirit and scope of the above described invention.

In this specification, the terms ‘comprises’, ‘comprising’, ‘includes’, ‘including’, ‘having’, ‘provided with’, or similar terms are intended to mean a non-exclusive inclusion, such that a method, system or apparatus having an inclusion of a list of elements may not necessarily include those elements solely, but may also include other elements not listed. For example, a separator device 100 described herein used for classification purposes may comprise or may not comprise certain features or elements that may be found on a separator device 100 described herein used for flotation purposes.

### LIST OF REFERENCE IDENTIFIERS

1 Separator device (PRIOR ART)
2 Slurry inlet
3 Tank wall
4 Fluidization fluid inlet
5 Lamellae or spaced (e.g., parallel) inclined plates
6 Upper separation chamber
7 Separation chamber (main)
8 Fluidization fluid distribution chamber
9 Lower outlet
10 Openings (e.g., perforations, slots, orifices, or nozzles).
11 Fluidization fluid panel
12 Incoming fluidization fluid
13 Incoming slurry
14 Underflow
15 Overflow
16 Weir
17 Launder
100 Separator device (INVENTION)
102 Slurry inlet
103 Tank wall
104 Fluidization fluid inlet
106 Upper separation chamber
107 Separation chamber (main)
108 Optional fluidization fluid distribution chamber
109 Lower outlet
110 Optional openings (e.g., perforations, slots, orifices, or nozzles).
111 Fluidization fluid panel
112 Incoming fluidization fluid (e.g., a liquid such as process water)
113 Incoming slurry
114 Underflow
118 Air or gas
(118) Optional air or gas
119 Flexible perforated membrane sparger
120 Main feed line
121 Manifold
122 Means for supplying pre-sheared aerated fluidization fluid
123 Flow indicative transmitter (FIT)
124 Control valve
125 Control signal
126 Shearing device (e.g., inline static mixer, cavitation tube, cavitation nozzle, chaos mixer)
127 Branch feed line
128 Connecting means
129 Microbubbles
130 Sparger feed device
131 First inlet
132 Second inlet
133 Upper segment
134 Middle segment
135 Lower segment
136 Aeration insert
137 Bolts, nuts, and/or equivalent fasteners
138 Flange(s)
139 Annular body
140 Inlet flange
140a Tubular portion
140a Flange portion
141 Receiving portion
142 First threaded end
143 Pipe connector
144 Gasket
145 Endcap
145a Tubular body portion
145b Flange portion
145c Gaseous liquid inlet hose connecting portion
145d Through opening
146 Second threaded end
147 Holes
148 Catchment (and/or sparger-supporting) device
149 Opening
200 Method
201-210 Method steps
300 Method
301-308 Method steps

What is claimed is:

1. A separator device (100) comprising:
a separation chamber (107) defined at its lower end by a fluidization fluid panel (111), and being defined on its sides by a tank wall (103);
a lower outlet (109) provided at a lower end of the separator device (100) and extending downwardly through a central region of the lower fluidization fluid panel (111);
a launder (117) provided at an upper end of the separator device (100);
a slurry inlet (102) for receiving incoming slurry (113) into the separation chamber (107);
CHARACTERIZED IN THAT the separator device (100) further comprises means (122) for supplying pre-sheared aerated fluidization fluid to the separation chamber (107) above the fluidization fluid panel (111), said means (122) including:
i.) a sparger (119) provided above the fluidization fluid panel (111) and comprising a flexible perforated membrane, and,
ii.) a shearing device (126) selected from the group consisting of: a static inline mixer, a cavitation tube, a cavitation nozzle, and a chaos mixer;
wherein the shearing device (126) is configured for producing the pre-sheared aerated fluidization fluid by passing a mixture of combined fluidization fluid (112) and gas (118) through the shearing device (126).

2. The separator device (100) according to claim 1, wherein the sparger (119) is configured as one of the group consisting of: a straight tube, a curved tube, a coil, a disc, a puck, a panel, and a plate.

3. The separator device (100) according to any one of the preceding claims, wherein the sparger (119) is fed at one of its ends with the pre-sheared aerated fluidization fluid.

4. The separator device (100) according to any one of the preceding claims, wherein the sparger (119) is fed at both of its ends with the pre-sheared aerated fluidization fluid.

5. The separator device (100) according to any one of the preceding claims, further comprising a plurality of said sparger (119).

6. The separator device (100) according to claim 5, wherein each of the plurality of said sparger (119) are nested and/or packed together.

7. The separator device (100) according to claim 5 or 6, wherein each of the plurality of said sparger (119) are of different sizes or shapes.

8. The separator device (100) according to any one of claims 5-7, wherein each of the plurality of said sparger (119) are oriented differently in space with respect to components of the separator (100) device.

9. The separator device (100) according to any one of the preceding claims, wherein the sparger (119) is horizontally-arranged.

10. The separator device (100) according to any one of the preceding claims, wherein the sparger (119) is inclined so as to follow an angle of the fluidization fluid panel (111).

11. A method for separating particles within an incoming slurry (113) using the separator device (100) according to any one of claims 1-10, comprising the steps of:
providing the separator device (100) according to any one of claims 1-10;
combining a gas (118) with a fluidization fluid (112) using the shearing device (126);
shearing the combined gas (118) and fluidization fluid (112) a first time using the shearing device (126) to produce a first sheared aerated fluid;
passing the first sheared aerated fluid through the sparger (119);
shearing the first sheared aerated fluid a second time through openings or perforations extending through the flexible perforated membrane of the sparger (119) to produce a twice-sheared aerated fluid;
uniformly distributing fine bubbles within the twice-sheared aerated fluid throughout the separation chamber (107) of the separator device (100);
segregating particles within the separation chamber (107) based on their size, density, hydrophobicity, or mineral composition; and,
removing the segregated particles via the launder (117) and lower outlet (109).

12. The method according to claim 11, further comprising the step of:
intermittently or periodically boosting the pressure or flow of the first sheared aerated fluid provided to the sparger (119);
expanding or flexing the flexible perforated membrane by virtue of boosting the pressure;
allowing the openings or perforations extending through the flexible perforated membrane of the sparger (119) to expand, and thus allow the first sheared aerated fluid provided to the sparger (119) to pass therethrough at an elevated velocity and/or energy; and
clearing obstructions or dislodging one or more particles from the openings or perforations extending through the flexible perforated membrane of the sparger (119) by virtue of the elevated velocity and/or energy and/or by virtue of expansion of the openings or perforations extending through the flexible perforated membrane of the sparger (119).

13. The separator device (100) according to any one of claims 1-10 further comprising an upper segment (133), a middle segment (134), and a lower segment (135) collectively forming a tank wall (103) of the separator device (100);
wherein the middle segment (134) comprises an aeration insert (136) having one or more of the sparger (119) provided thereto.
